(19) United States
(12) Patent Application Publication
(10) Pub. No.: US 2017/0233991 A1
(43) Pub. Date: Aug. 17, 2017

(54) Floor Drain Gas Stopper

(71) Applicant: Daniel J. Atha, Williston, ND (US)

(72) Inventor: Daniel J. Atha, Williston, ND (US)

(21) Appl. No.: 15/044,106

(22) Filed: Feb. 16, 2016

(51) Int. Cl. E03C 1/298; F16K 31/22; F16K 15/04

(52) U.S. Cl. CPC E03C 1/298; F16K 15/04; F16K 31/22

(57) ABSTRACT

Disclosed herein is a trap assembly for draining waste water toward sewer pipes while blocking back flow of odors. In a preferred embodiment the trap assembly comprises of a housing having a hollow interior, open, upper and lower ends. The housing is connected to a drain pipe at the lower end and extending outwardly therefrom into a substantially vertical orientation, a valve member formed of buoyant material; a retainer assembly connected to said housing in an at least partially supporting relation to a valve member. Further the valve member disposable into and out of sealing engagement with the valve seat dependent on direction of liquid flow along a flow path.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates generally to valving mechanisms. More particularly, the invention concerns a device for use in waste lines and the like which permits fluids to flow freely into the drain of the waste line, but positively prevents gases.

(2) Background

Human excrement smells unpleasant and, unless carefully disposed of, transmits diseases. A major development in the disposal of human excrement was Sir Thomas Crapper's water closet, which has hardly changed unto this day.

Essentially, excrement is deposited into a bowl of water coupled to a sewage pipe by a U shaped tube. The sudden emptying of a large quantity of water into the bowl causes the contents thereof to be flushed through the U tube into the sewage pipe. The U tube remains full of water and prevents noxious smells from the sewage pipe from permeating back into the water closet.

Unfortunately, users of water closets or toilets, themselves, may release quantities of gases together with waste products. Additionally, if the toilet is not flushed frequently, as may be the case during water shortages, and the like, or until flushed, the contents thereof may release foul smells into the air within the generally small confines of the toilet.

Preferably, toilet rooms should be well ventilated with a window to the outside. In practice, this is not always possible, and often, to save space, toilets are positioned under staircases and in other places, where windows are not possible. An alternative solution is to provide a duct to the outside, and to use an extractor fan to pump air into such a duct. Such a duct is usually positioned in or near the ceiling. For privacy, toilet windows are usually small and positioned high up as well. The problem with both windows and such extractor fans is that the gases have to diffuse, typically by Brownian motion, throughout the small confines of the toilet. In consequence thereof, such gases may be inhaled by users. Particularly in public places where the number of users of toilets is large, windows or extractor fans of the types discussed here above are not ideal solutions.

A technology describes a toilet ventilating system for use with a bowl incorporating a sewer line connection and including an upstanding vent conduit leading from the bowl rim outlets to an elevated cross over in the water storage tank and then dropping downwardly to form an exhaust conduit connected with the sewer connection. A centrifugal fan having a flow rate of 60 cubic feet per minute is incorporated in the vent conduit and a trap valve is incorporated in the cross over for selectively opening and closing communication between the vent conduit and the exhaust conduit. The trap valve incorporates a floating cylinder, the positioning of which is controlled by water pumped from an elevated reservoir through a positive displacement pump. A controller is provided for controlling the positive displacement pump to open the trap valve, actuation of the centrifugal fan and closure of the trap valve, deactivation of the fan and actuation of the flush valve.

The system is designed for use with mono-block type toilets, and has a relatively complicated mechanism for venting odors to the sewage line after the u shaped trap.

Another, describes a toilet assembly having an automatic ventilation system which includes a high-powered suction member, an innovative motion sensor, a siphonic action member, and discharging member for objectionable odor. While the user sits on the toilet seat ring, the objectionable odor is effectively ventilated. When the user stands up and pushes a flush push button, the toilet assembly is effectively flushed.

The mechanism described includes sensors and electromagnets and is complicated and not too reliable.

The solution described is advantageous in that everything is coupled to the toilet seat and can be retrofitted onto a wide range of standard toilets. However, the solution is complicated and inherently unreliable. An air treatment assembly box is provided to the side and below the position where the bowl and tank are joined. Conduit pipes run along the seam coupling the bowl and tank. Urine from males with poor aim will tend to run along the outside of the conduits to the box. cl BRIEF SUMMARY OF THE INVENTION

Primarily the invention is a trap assembly for draining waste water toward sewer pipes while blocking back flow of odors.

In a preferred embodiment the trap assembly comprises of a housing having a hollow interior, open, upper and lower ends. The housing is connected to a drain pipe at the lower end and extending outwardly therefrom into a substantially vertical orientation, a valve member formed of buoyant material; a retainer assembly connected to said housing in an at least partially supporting relation to a valve member. Further the valve member disposable into and out of sealing engagement with the valve seat dependent on direction of liquid flow along a flow path.

Further the housing of the trap assembly for draining waste water toward sewer pipes while blocking back flow of odors further comprises of a head assembly removably secured within the upper end of the housing, the head assembly includes a hollow interior and open proximal and distal ends.

Also, according to the invention the valve member is movably contained within the housing and along the flow path. Further, the retainer assembly is disposed to normally retain said valve member out of said flow path.

Furthermore, the trap assembly for draining waste water toward sewer pipes while blocking back flow of odors the valve seat is removably mounted on the head assembly. The valve seat and the upper end collectively define at least a portion of a flow path through the housing.

The summary is provided to introduce a selection of concepts in a simplified form that are further described below in the detailed description. This summary is not intended to identify key features or essential features of the subject matter, nor is it intended to be used as an aid in determining the scope of the subject matter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a general perspective view showing the parts of the floor drain h2s gas stopper in accordance with the present invention.

FIG. 2 is a top plan view of the floor drain h2s gas stopper.

FIG. 3 is a top plan view of an embodiment of a floor drain cover.

FIG. 4 is a bottom plan view of the floor drain h2s gas stopper without the floor draw cover; and:

FIG. 5 is top plan view of the floor drain h2s gas stopper without the floor draw cover.

### DETAILED DESCRIPTIONS OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make such embodiments obvious to a person of ordinary skill in the art.

According to the trap assembly for draining waste water toward sewer pipes while blocking back flow of odors, keeps the floor drain trap from drying out preventing H2S gases into the houses or facility. One inventive feature of the present invention is the removable mounting or connection of the housing, as well as the remaining components of the flood valve assembly of the present invention, on the interior of the drain pipe. To accomplish such removable attachment, the present invention also comprises an attachment assembly, which is preferably adjustably disposed at least partially within the interior of the housing. The attachment assembly is preferably defined by at least one, but preferably, two cross members disposed in substantially transverse relation to one another, and further, which are specifically structured such that their length may be varied.

In one embodiment the invention is a trap assembly comprises of a housing 100 having a hollow interior, open, upper and lower ends. The housing 100 is connected to a drain pipe 101 at the lower end and extending outwardly therefrom into a substantially vertical orientation, a valve member formed of buoyant material; a retainer assembly connected to said housing in an at least partially supporting relation to a valve member.

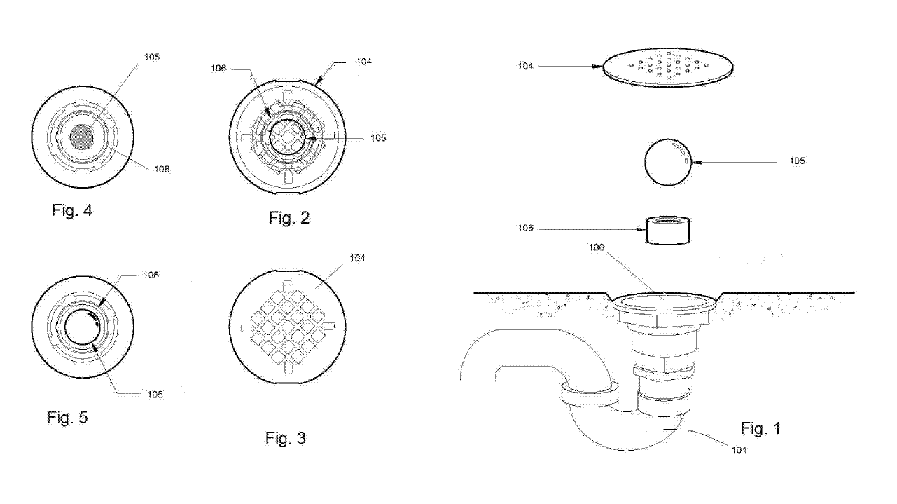

FIG. 1 shows the parts of the present floor drain h2s gas stopper comprising the housing 100, a ball seal 106, a gas stop ball 105 and a floor drain cover 104.

Further the valve member disposable into and out of sealing engagement with the valve seat dependent on direction of liquid flow along a flow path. And the housing of the trap assembly for draining waste water toward sewer pipes while blocking back flow of odors further comprises of a head assembly removably secured within the upper end of the housing, the head assembly includes a hollow interior and open proximal and distal ends.

Also, according to the invention the valve member is movably contained within the housing and along the flow path. Further, the retainer assembly is disposed to normally retain said valve member out of said flow path. The trap assembly for draining waste water toward sewer pipes while blocking back flow of odors the valve seat is removably mounted on the head assembly. The valve seat and the upper end collectively define at least a portion of a flow path through the housing. The specific structural embodiment of each of the cross members may take the form of a hexagon shaped turnbuckle or “hex-turnbuckle” having a threaded bolt protruding from each opposite end thereof.

Further, the ball 105 rest on a seal 106 preventing gases to escape. The water in the trap will stay for months with a plastic ball in place giving a double seal. Water and the ball rest on the seal. It also allows water to drain freely down trap. The float or gas stopper to allow water to drain and stop gases from entering home or facility from a dry floor. The float or gas stopper rest on the seal to prevent floor drain water from evaporating and allowing H2S gases from entering your home or facility from dry floor.

The opposite extremities of each of the threaded bolts preferably have a sharpened or pointed configuration which extends through pre-formed openings or apertures in the body of the housing such that the sharpened ends of the cross members may penetrate, and thereby, removably engage the interior surface of the standing drain pipe.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. The dimension mentioned herein is an approximate value and in no way limits the scope of the invention.

Although the invention has been explained in relation to its preferred embodiment, it is to be understood that many other possible modifications and variations can be made without departing from the spirit and scope of the invention.

1. A trap assembly for draining waste water toward sewer pipes while blocking back flow of odors and preventing evaporation of drain water, said assembly comprising:
a housing having a hollow interior, and open upper and lower ends, said housing connected to a drain pipe at said lower end and extending outwardly therefrom;
a sealing engagement mounted on the upper end of the housing, said sealing engagement being a tubular hollow structure having an upper end and a lower end, and the upper end of the sealing engagement being a valve seat;
a valve member, being a ball formed of buoyant material and having a size such that it closes the upper end of the sealing engagement when resting on the valve seat;
wherein in presence of water in the housing, said valve member floats on the water leaving the upper end of the sealing engagement open for water flow and in absence of water in the housing said valve member closes the upper end of the sealing engagement, thereby preventing backflow of odors and water evaporation from the drain pipe.

2. The trap assembly of claim 1, wherein said valve member is made of plastic.

3. The trap assembly claim 1, wherein the assembly is covered by a floor drain cover.

4. (canceled)

5. (canceled)

6. (canceled)

7. (canceled)

8. (canceled)
